(19) United States
(12) Patent Application Publication
(10) Pub. No.: US 2006/0256073 A1
(43) Pub. Date: Nov. 16, 2006

(54) Control panel using ray-of-light to enhance control-display relationships

(75) Inventor: Brandon L. Satanek, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/126,836

(22) Filed: May 11, 2005

(51) Int. Cl. G09G 5/00

(52) U.S. Cl. 345/156

(57) ABSTRACT

A control panel has a screen for displaying instructions, objects, status information and the like. The control panel also includes a user interface comprising a number of button, include at least one select button which is configured to select from among one or more options displayed on the screen. The select button is visually connected to an option displayed on the screen. The visual connection is formed by a first light portion extending from the button to the edge of the screen, and a second light portion displayed on the screen itself, the second light portion extending from the edge of the screen proximate to where the first light portion terminates, to option. The width, color and/or visual pattern of the first and second portions may be similar so as to accentuate the connectedness between the button and the option. Such a control panel may be associated with a standalone photograph printer.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to a user-operated control panel for controlling equipment. More particularly it concerns a control panel having a display configured to present one or more selections which may be selected by pushing one or more corresponding buttons on the control panel. The equipment itself may be office equipment, such as copies, printers or fax machines; it may be Automated Teller Machines; and may even be vehicles, machinery or other devices.

2. Description of the Related Art

In many modern interactive products, it is often necessary to develop control-display relationships. Controls include interactive physical objects like buttons or knobs. Displays generally include various visual output technologies such as monitors or LCD screens affected by the control. To enhance the usability of a system, the relationship between the control and its effect on the display must be very clear. One of the classic usability problems illustrating this issue is trying to decipher which control knob across the back-edge of a stove affects a particular heating burner in front.

Several methods have been used to help enhance the control-display relationship. Included among these methods are: (1) placing the control as close as possible to the region on the affected screen; or (2) providing a line or raised connector between the control and the edge of the display. These methods are typified in ATM machines. Buttons often surround the edge of the ATM display and, to further enhance the relationship between the button and an option on the screen, an arrow or bar on the display connects the option to the edge where the button is located. In other ATMs, the button is spaced apart from the edge and a raised or engraved line connects the edge of the display where the arrow or bar ends, to the button. These techniques are also employed in copiers, printers and all-in-one devices. For example, in the Lexmark P6250 all-in-one unit, the ‘Number of Copies’ and the ‘Resize’ buttons are both located close to regions on the LCD screen that display the Copies/Size values and both have raised lines from the button to the edge of the screen.

One advantage of these ATM-style button screen combinations is that they provide a cost savings over a touchscreen. However, the relationship between the control and the display is not completely explicit. A user must mentally connect the button to the element on the display screen using a series of implied visual cues as previously described. Often, the cues tend to be very subtle and easily overlooked, given the number of other distracting design elements present. Further, when the ATM control panel is not well lit, this problem is exacerbated. The danger of missing these cues ranges from being lost in the user interface and not knowing how to complete a task (or which button to press to complete the task) to pressing an incorrect button, all of which wastes time. In the typical ATM scenario, this could mean withdrawing from the wrong account, or the wrong amount. In an AIO scenario, it could mean inadvertently canceling a copy request. In scenarios where it involves a user interface panel associated with a vehicle, machinery or other motorized equipment, the consequences can even be more severe.

### SUMMARY OF THE INVENTION

In one aspect, the present invention is directed to a control panel comprising at least one screen configured to display at least one option; a user interface comprising at least one button configured to select said at least one option, when said first button is activated; and a visual connection between the at least one button and the at least one option, the visual connection comprising a first light portion extending between the at least one button and a first point proximate an edge of the screen; and a second light portion extending between a second point within the screen and the at least one option displayed on the screen, wherein the first and second points are sufficiently close to one another so as establish an association between the at least one button and the at least one option.

In another aspect, the present invention is directed to a control panel comprising at least one screen configured to display an object along with information about a status of the object, the information being displayed at a predetermined location on the screen; a user interface comprising at least one button configured to affect the status of said object; and a visual connection between the at least one button and the information, the visual connection comprising a first light portion extending between the at least one button and a first point proximate an edge of the screen; and a second light portion extending between a second point within the screen and the predetermined location, wherein the first and second points are sufficiently close to one another so as establish an association between the at least one button and the information.

In still another aspect, the present invention is directed to a method of linking an option displayed on a screen to a button configured to select the option, the button not being on the screen. The inventive method comprises illuminating a first light portion extending between the button and a first point proximate an edge of the screen; and illuminating a second light portion extending between a second point within the screen and the at least one option displayed on the screen, wherein the first and second points are sufficiently close to one another so as establish an association between the button and the option.

### BRIEF DESCRIPTION OF THE DRAWINGS

The patent or application file contains at least one drawing executed in color. Copies of the patent or patent application publication with color drawings(s) will be provided by the Office upon request and payment of the necessary fee.

FIG. 1 shows a photograph printer having an configuration in accordance with an embodiment of the present invention;

FIG. 2 shows the resulting display on the control panel after a photo card is inserted into the slot;

FIG. 3 shows the result of pushing the “select” button 130 when the device is in the state depicted in FIG. 2;

FIG. 4 shows the result of pushing the “select” button when the device is in the state depicted in FIG. 3;

FIG. 5 shows the effect of pushing the “select” button when the device is in the state depicted in FIG. 4;

FIG. 6 shows the effect of pushing the “next” button when the device is in the state depicted in FIG. 5;

FIG. 7 shows the effect of pushing the “print” button when the device is in the state depicted in FIG. 6;

FIG. 8 shows the panel upon completion of a print operation;

FIG. 9 is similar to FIG. 8, but shows a second option as the currently selected option; and

FIG. 10 shows the effect of activating the “edit” button from the state shown in FIG. 4.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

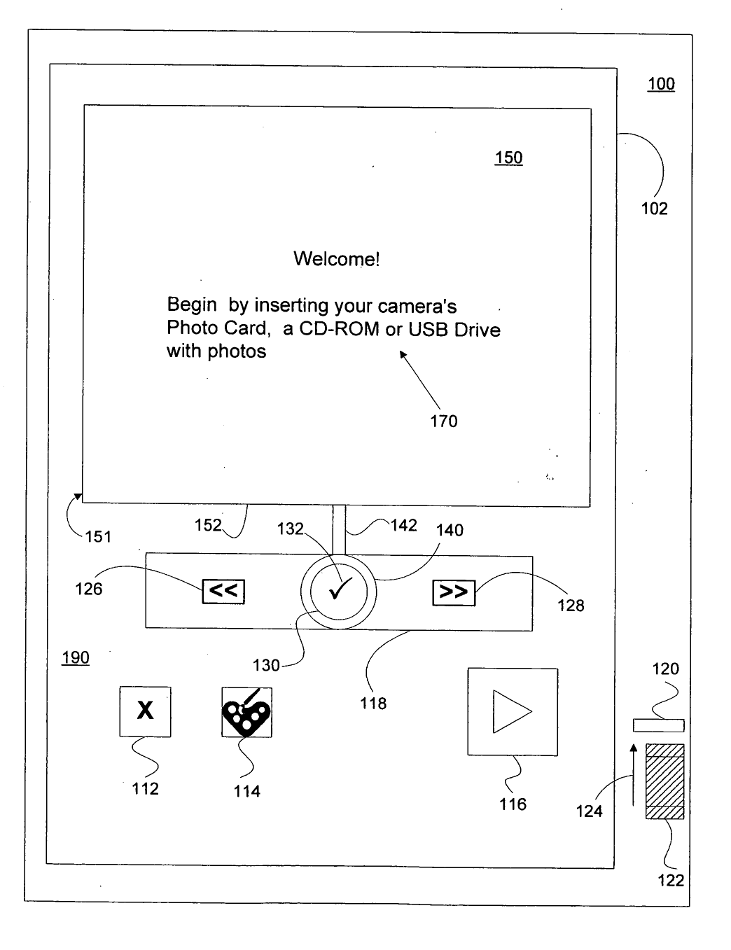

FIG. 1 shows a device 100 having an configuration in accordance with one embodiment of the present invention. In this embodiment, the device 100 is a standalone photograph printer of the sort used to print photos.

The device 100 includes a control panel 102 which comprises a display or screen 150 for presenting instructions, options, status information, and the like, to an operator. The control panel also includes a user interface 190 comprising a number of manually actuable buttons 112, 114, 116, 126, 128 and 130 for making selections.

The screen 150 preferably is a backlit, color bit-mapped screen of the sort well known to those of skill in the art. The screen 150 has a perimeter 151 which, in the embodiment shown, includes a bottom edge 152. Among other things, instruction and status messages 170 may be displayed on the screen to assist an operator.

In FIG. 1, the instruction message 170 displayed on the screen 150 asks the operator to take appropriate steps to download the photographs to the device 100. A slot 120 is provided on the device 100 to receive a photo card 122 or memory stick of the sort used in a camera. As seen in FIG. 1, the photo card 122 is in a first position where it is detached from the device and so has not yet been inserted. As is known to those skilled the in art, the photo card 122 can be inserted into the slot 120 in the direction of arrow 124. Once in the slot 120, the photo card 122 typically is held in place by a mechanism internal to device 100 until such time as the photo card 122 is ejected.

In other embodiments, as indicated by the instruction message 170, the camera may be directly connected to the device via a USB or other port. In still other embodiments, the device 100 is provided with a memory drive, such as a CD or DVD read-write drive, and the CD or DVD disk on which a camera records the photographs is inserted into the drive for printing.

The buttons on the user interface 190 include a cancel (or “go back’) button 112, an edit button 114 and a print button 116. A separate group 118 of buttons is associated with selections and options displayed on the screen 150. The button grouping 118 includes a previous button 126 for moving to a previous option, a next button 128 for moving to a next option, and a select button 130 to accept the current option.

In one embodiment, the select button 130 is selectively backlit by a light emitting diode (LED) that is controlled in a known manner. It is understood that the button 130 need not be round, but instead may take on other shapes, such as square, rectangular, oval, and triangular, among others. The upper face of the select button 130 is provided with a symbol 132, seen in FIG. 1 as a check mark (“✓”). Preferably, the symbol forms a translucent portion of the button 130 and so when the button 130 is backlit, light passes through the symbol 132, making the symbol more visible.

As seen in FIG. 1, the button 130 is visually connected to the edge 152 of the screen 150 via a first light portion. In one embodiment, the first light portion comprise a light pipe 142 (sometimes also referred to as a ‘light guide’) that connects to an illuminable region adjacent the button 130. In this instance, the adjacent region 140 comprises a translucent circumferential band or button halo 140 associated with the edges of the button 130. The halo 140 is optically connected to the light pipe 142. When backlit, the halo 140 and the light pipe 142 visually link the button to the screen edge 152. While a circumferential band 140 is shown, it is understood that the adjacent region 140 can take on some other shape—for instance, it may be a semi-circular band following a portion of the contour of the button, a dot adjacent the button, a line bar transverse to the light pipe 142, or some other shape.

A single LED may be used to illuminate the button symbol 132, the adjacent region 140 and the light pipe 142. This creates an illuminated ‘ray-of-light’ connection from the button 130 to the screen edge 152.

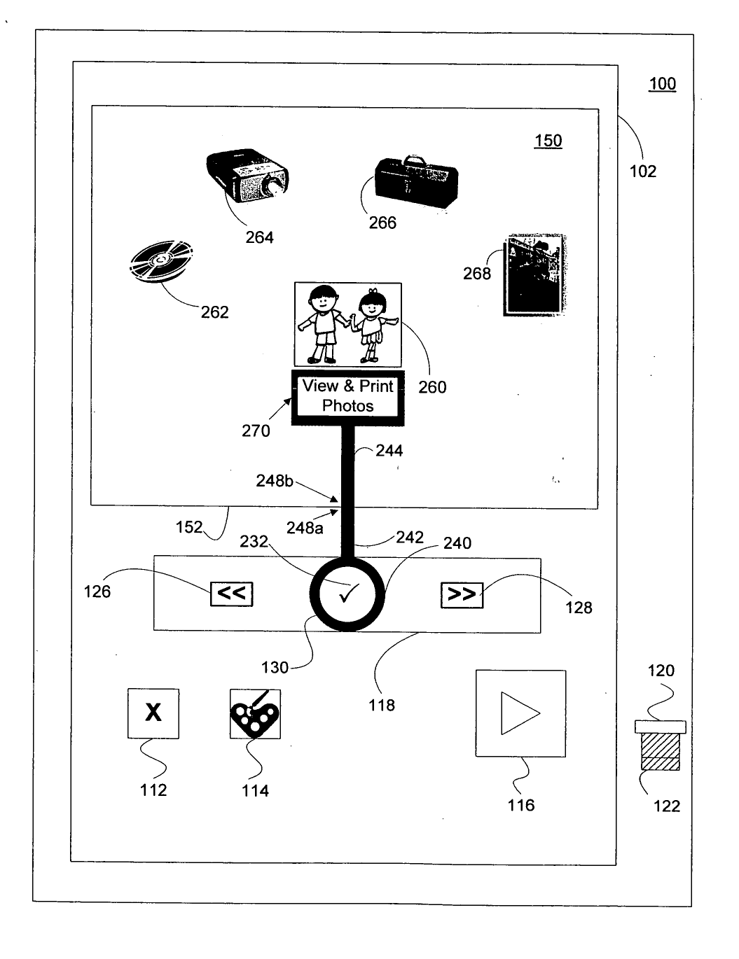

FIG. 2 shows the resulting display on the control panel 102 after the photo card 122 is inserted into the slot. First, the device 100 reads into memory the contents of the photo card 122. Next, the screen 150 displays a number of icons, each representing an option that an operator may select. A currently selectable option appears in the middle of the screen along with an informational message 270 regarding the option. The operator can use the previous button 126 and the next button 128 buttons to make another icon become the currently selectable option. In FIG. 2, the currently selectable option is represented by a single photograph icon 260 and the informational message 270 states that this option allows one to view and print photos. Other options that may become selectable are represented by a disk icon 262 for writing the photographs onto a disk, a projector icon 264 for viewing the photographs as a slide show; a toolbox icon 266 for adjusting the toner cartridges and performing other maintenance, and a multiple photo icon 268 for printing all photographs. It is understood that the information message 270 will change with the currently selectable option.

Importantly, as seen in FIG. 2, a second light portion 244, also in the form of a light bar, also appears on the screen 150. While the light pipe 242 terminates at a first point 248a proximate the screen edge 152, the light bar 244 extends from a second point 248b proximate the screen edge 152 but within the screen area, to the currently selectable option 270. The first point 248a and the second point 248b are sufficiently close to one another that the first light portion and the second light portion together establish association between the select button 130 and the currently selectable option 270.

Other features may help further establish this association. For instance, at the first and second points 248a, 248b, the widths of the light pipe 242 the on-screen light bar 244 may be similar to one another. Also, sections of the light pipe 242 and the on-screen light-bar 244, proximate the screen edge 152, may line up with one another (i.e., be collinear), further implying continuity between the two. In addition, the illuminated button halo 240, the illuminated light pipe 242 and the on-screen light bar 244 may all have a common color. This can be provided for by drawing a light bar 244 on the screen 150 that is similar to the illuminated button halo 240 and light pipe 242. In one embodiment, the light bar and LED are both either green or blue to impart this common color. In addition, or in lieu of, a common color, the illuminated button halo 240, the illuminated light pipe 242 and the on-screen light bar 244 may have a common visual pattern—such as a cross-hatch to thereby show a continuous visual link between the button 130 and the currently selectable option 270. Also, the LED illuminating the button halo 240 and the light pipe 242, and the light bar 244, may flash in unison at a predetermined flash rate. Alternatively only the LED or the light bar 244 may flash, the other remaining constantly illuminated. These features help further draw attention to the association between the button 130 and the currently selectable option. In this manner, the button 130 is visually connected to the currently selectable option appearing on the screen 150 via an illuminated non-screen area of the control panel 102 which includes the button symbol 232, the button halo 240, and the light pipe 242, and an on-screen light bar 244 appearing on the screen 150 itself.

In this manner, the select button 130 is visually connected to a selectable option on the screen 150 via a first light portion appearing on a non-screen area of the control panel 102, and a second light portion appearing on a screen area of the control panel. In one embodiment, the first light portion comprises a light pipe 242 and, when present, an adjacent region 240 and/or a button symbol 232, while the second light portion comprises an on-screen light bar 244.

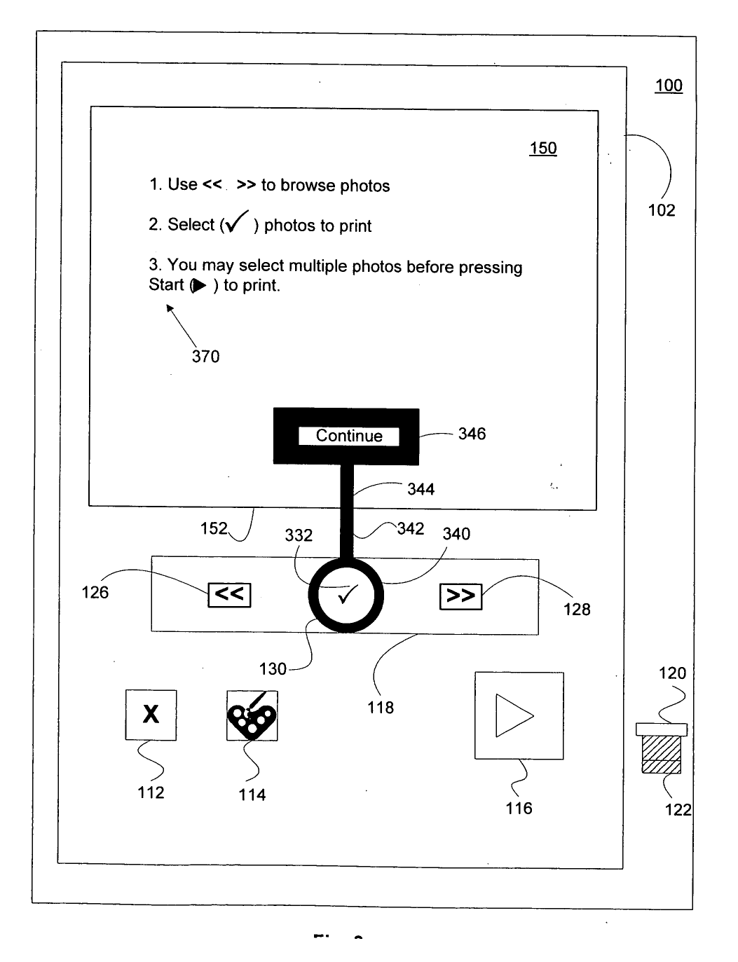

FIG. 3 shows the result of pushing select button 130 when the device is in the state depicted in FIG. 2. An informational message 370 appears providing additional instructions to the operator. On how to browse through the downloaded photos, select particular photos for printing, and how to commence a printing operation using the print button 116. From the state shown in FIG. 3, an operator may proceed with the viewing and printing of photographs by simply pushing the button 130. In FIG. 2, button 130 is visually connected to a currently selectable option 346 to “continue” with the viewing and printing. In such a manner, the button 130 is visually connected to the currently selectable option 346 appearing on the screen 150 via an illuminated non-screen area of the control panel including the button symbol 332, the button halo 340, and the light pipe 342, and an illuminated on-screen light bar 344 appearing on the screen 150 itself. Again, either or both the LED and the second light portion may flash to further accentuate the visual nexus.

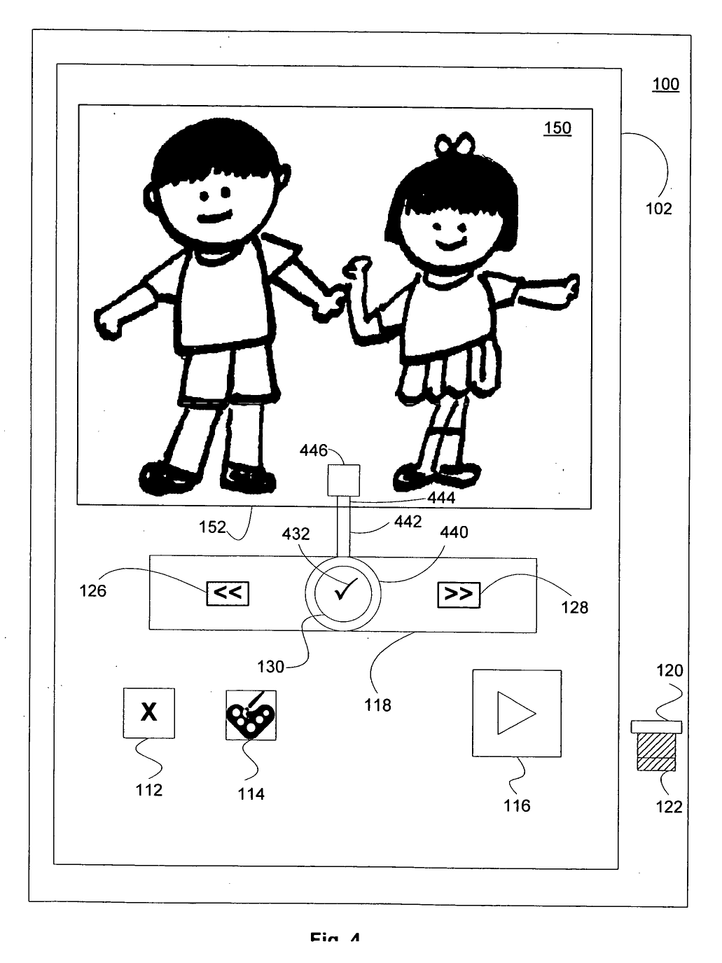

FIG. 4 shows the result of pushing select button 130 when the device is in the state depicted in FIG. 3 and continuing with the viewing and printing of photographs. A first of the downloaded photographs appears, occupying nearly the entire screen 150. A status indicator 446, which in the embodiment seen in FIG. 4 appears as a small square box, also appears on the screen 150 at a predetermined location. The status indicator 446 is configured to indicate a status of an object displayed on the screen 150. In this instance, the status indicator 446 indicates whether this particular photograph has been selected for printing. The button 130 is visually linked to the status indicator 446 via a button halo 440 and a light pipe 442, both of which are on non-screen areas of the control panel, and also an on-screen light bar 444. As seen in FIG. 4, the status-indicator 446 is empty, and the button symbol 432, the button halo 440, the light pipe 442 and the on-screen light bar 444 appear un-illuminated, in outline form, indicating that that photograph shown has not yet been selected for printing. By virtue of the informational message 370 in FIG. 3 and further in view of the un-illuminated outlines, an operator understands that pushing button 130 will select this first photograph for printing.

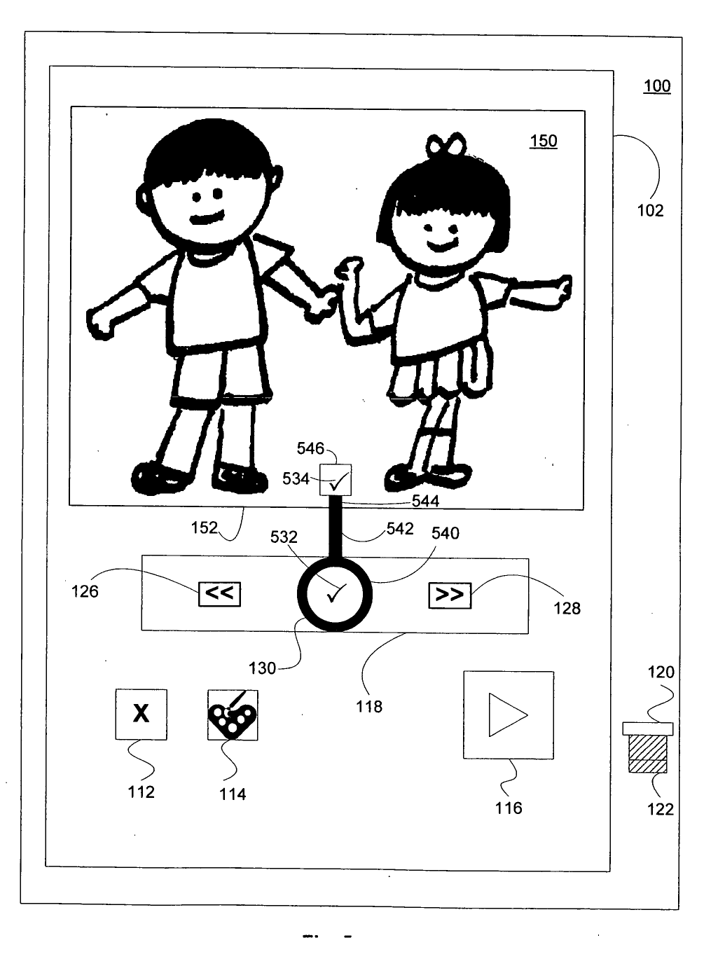

FIG. 5 shows the effect of pushing select button 130 when the device is in the state depicted in FIG. 4. This first photograph is selected for printing, and the ‘selected’ status is indicated by the illuminated button symbol 532, the illuminated halo 540, the illuminated light pipe 542, and the illuminated on-screen light bar 544. The selected status is further indicated by an illuminated on-screen symbol 534 appearing in the status indicator 546. At this stage, an operator may deselect the photograph by pushing select button once more. As seen in the embodiment of FIG. 5, the illuminated on-screen symbol 534 has a shape similar to that of the illuminated button symbol 532. Furthermore, in the “selected” state, the symbols 532, 534 have similar colors as well. It can be seen from the foregoing that if a photo has not been selected for printing, neither the button symbol 532, nor the on-screen symbol 534, nor the various other light portions and components thereof are illuminated. This allows an operator to quickly browse though the photos and determine which, if any, of the photos have been selected.

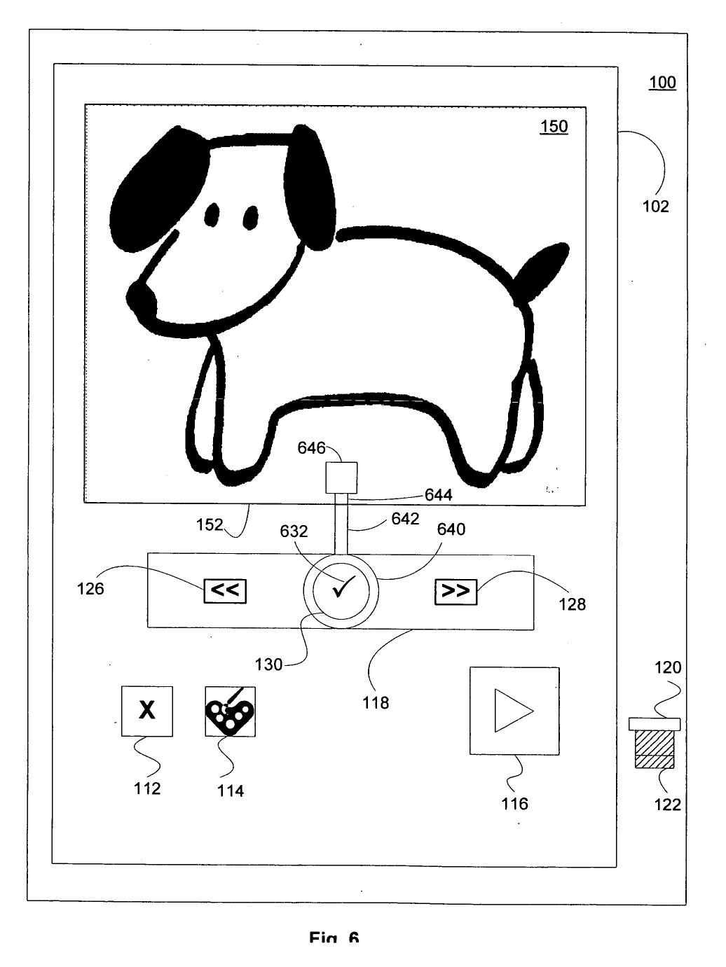

FIG. 6 shows the effect of pushing next button 128 when the device is in the state depicted in FIG. 5. A second photograph, which had initially been downloaded when the photo card 122 was first inserted, appears on screen 150 and the operator is provided with a situation similar to that seen in FIG. 4. The status-indicator 646 is empty, and the button symbol 632, the button halo 640, the light pipe 642 and the on-screen light bar 644 appear un-illuminated, in outline form, indicating that this second photograph has not yet been selected for printing. The operator is again permitted to push button 130 to add this second photograph to the collection of those to be printed, much as in the state depicted in FIG. 4. Upon pushing button 130, the control panel moves to the state depicted in FIG. 5. The operator is also allowed to go back to the previous photograph by pushing previous button 126, or proceed to the next photograph by pushing next button 128.

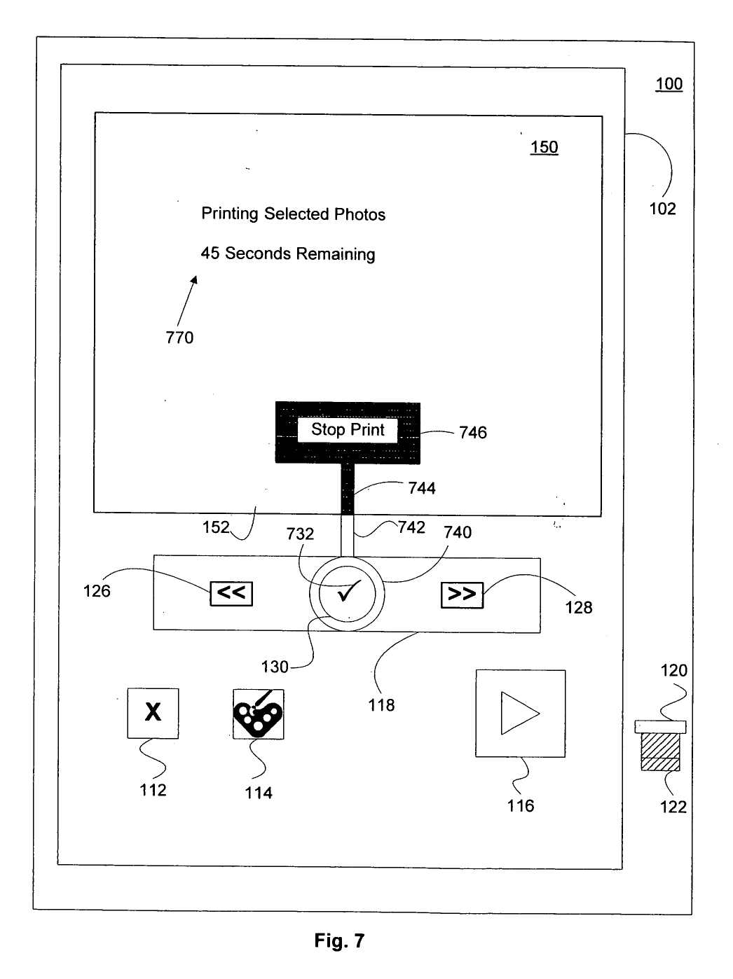

FIG. 7 shows the effect of pushing print button 116 when the device is in the state depicted in FIG. 6. The print button 116 causes the selected photographs to be printed, and results in the display of an informational message 770 indicating that the selected photographs are being printed and also showing the time remaining until the completion of the printing operation. Also displayed on the screen is a currently selectable option 746 which presents the operator with an option of stopping the printing process. In a preferred embodiment, the currently selectable option 746 comprises a colored box bearing the message “Stop Print” and is actuated by select button 130. A visual link between the select button 130 and the currently selectable option 746 is created by a first light portion comprising the button halo 740 and light pipe 742 and a second light portion comprising the on-screen light bar 744. As seen in the embodiment of FIG. 7, the button symbol 732, button halo 740 and light pipe 742 are all un-illuminated, indicating that the printing operation is proceeding. It is understood, however, that the currently selectable option 770 and/or the first light portion and/or the second light portion may all be illuminated in a common color, and that one or more of these may flash to form a visual link between the select button 130 and the currently selectable option 770.

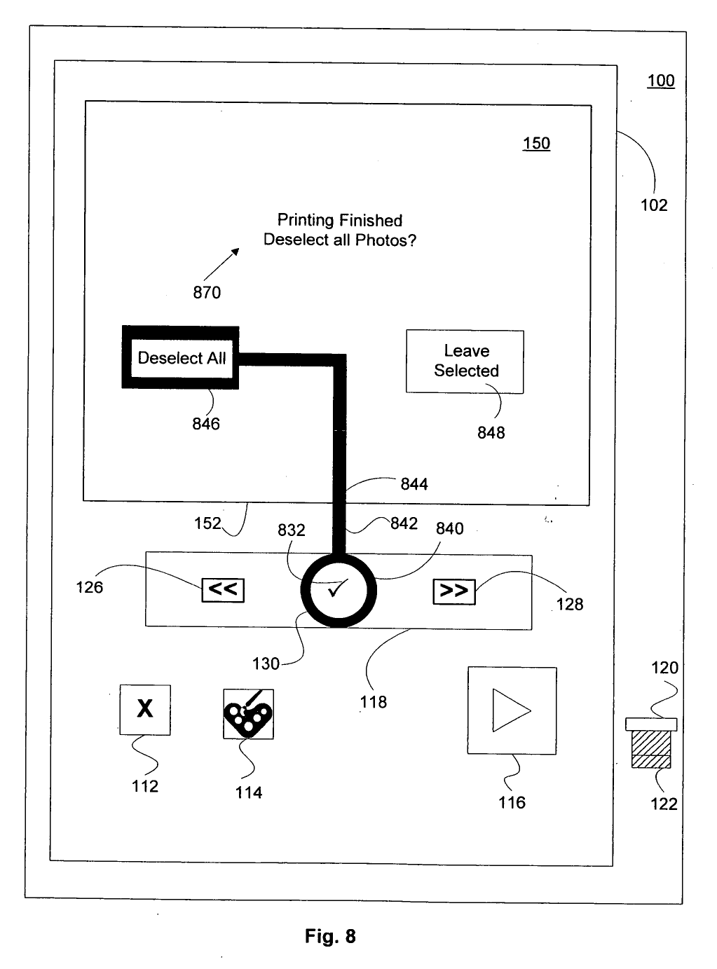

FIG. 8 shows the control panel 102 upon completion of a print operation. An informational message 870 appearing on the screen informs the operator that the printing operation is complete and asks whether the photographs should be deselected. Two options are presented to the operator. A first option 846, currently selectable in FIG. 8, is to deselect all photographs. A second option 848 is to allow the selected photographs to remain selected (for instance, to next write or copy these selected photographs to disk). An operator may switch between the first and second options by activating the previous button 126 or the next button 128, as appropriate.

A visual connection is formed between the select button 130 and the currently selectable option 846. This visual connection is formed by a first light portion comprising the button symbol 832, the button halo 840 and the light pipe 842, and a second light portion comprising an L-shaped on-screen light bar 844 connecting to the currently selectable option 846. As seen in FIG. 8, both the first light portion and the second light portion are illuminated in a common color, along with the currently selectable option 846. It is understood, however that only some of these components may be colored, or that one or more of these components may flash to further accentuate the nexus.

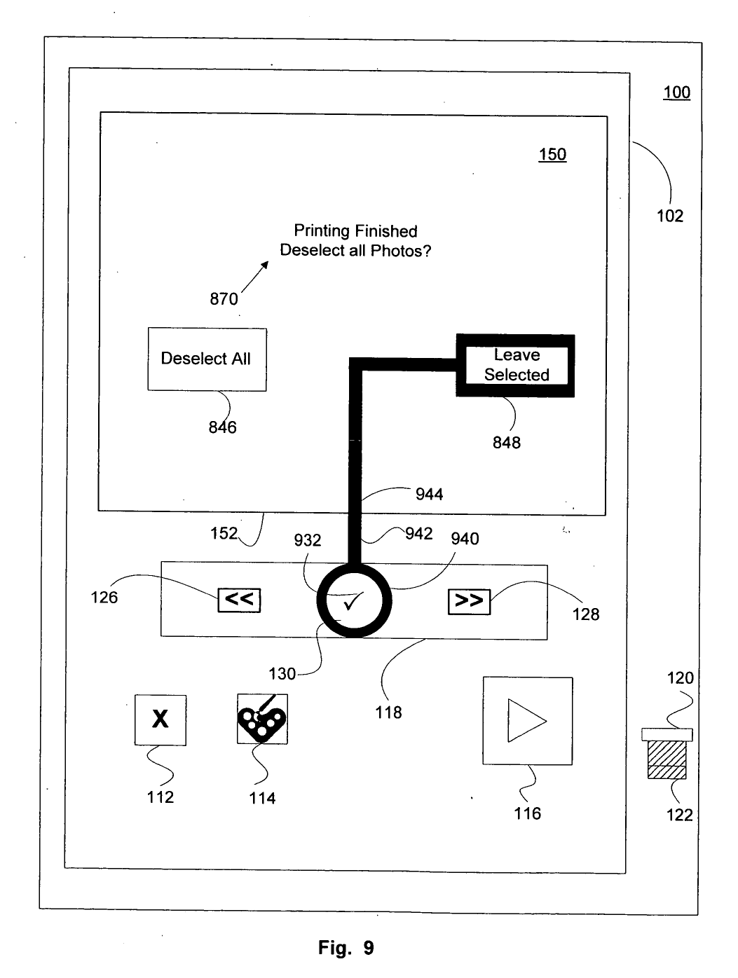

FIG. 9 is similar to FIG. 8, but shows the second option 848 as the currently selected option. In such case, the L-shaped on-screen light bar 944 faces in a direction opposite that of L-shaped on-screen light bar 844 of FIG. 8 and connects the currently selectable option 848 to light pipe 942 and button halo 940, the select button 130 itself bearing the illuminated button symbol 932. Thus, in FIG. 9, the illuminated button symbol 932, the button halo 940 and the light pipe 942 provide visual indicia on the non-screen area of the control panel, while the L-shaped on-screen light bar 944 provides visual indication on the screen areas of the control panel, much as in the case with FIG. 8. Again, only some of these components may be colored, and one or more of these components may flash to further accentuate the nexus.

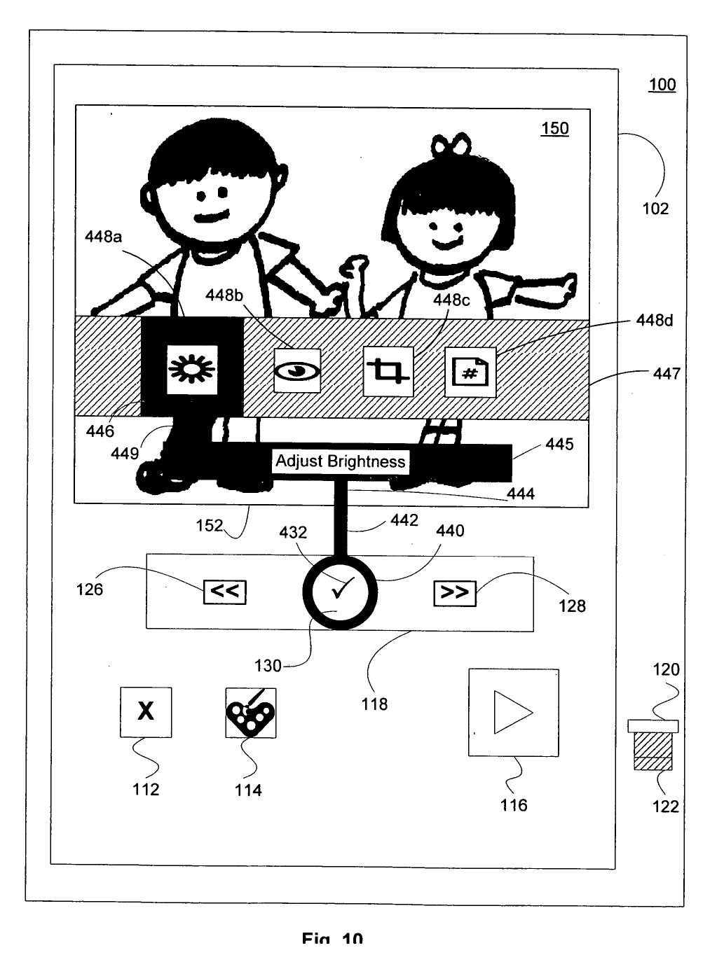

FIG. 10 shows the effect of activating the edit button 114 from the state shown in FIG. 4. An option bar 447 appears, presenting various editing functions. These editing functions include an ‘adjust brightness’ option 448a, a ‘remove red eye’ option 448b, a ‘crop photograph’ option 448c and a ‘number of copies’ option 448d. As seen in FIG. 10, the ‘adjust brightness’ option 448a is the currently selectable option 446. By activating the previous button 126 and the next button 128, any one of these options may become the currently selectable option. The currently selectable option 446 is visually connected to the select button 130 via a first light portion comprising the button halo 40 and the light pipe 442 on the non-screen portion of the control panel 102. On the screen 150 itself, the visual connection is continued by a second light portion comprising an on-screen light bar 444 which connects on-screen text bar 445 bearing, in this instance, the message “Adjust Brightness”. The on-screen text bar 445 is then connected to the currently selectable option 446 via an on-screen connecting bar 449. Thus, as seen in FIG. 10, the on-screen text bar 445 is interposed between the point at which the on-screen second light portion begins at the screen edge 152, and the currently selectable option 446. Together, the various components provide a continuous illuminated region from the select button 130 to the currently selectable option, thereby indicating the link between the two.

People skilled in art understand how to draw the appropriate lines, bars and other indicia on a screen and that the exact shapes, patterns, routing and configurations of the bars and other indicia displayed on the screen are left to the artisan. People skilled in the art are also familiar with fabricating a control panel provisioned with buttons, translucent button symbols, button halos and light pipes. Finally, people skilled in the art know how to control a device such that the illumination of an LED or other light source for the non-screen portion is configured to cooperate with the on-screen illumination to provide the visual connection between a select button and an currently selectable option.

The foregoing description has been presented in the context of a device specially configured to print photographs. However, in other embodiments, the target device benefiting from the present invention may be a copier, a printer, an all-in-one (printer-copier-scanner or printer-copier-scanner-fax), an automated teller machine, a control panel for equipment, or the like. Each of these devices can employ the combination of an illuminated first portion on a non-screen area of a control panel connecting to an illuminated on-screen area of the control panel to connect a button on the control panel to either an option or status information appearing on the screen or other on-screen selection.

In addition, the foregoing description illustrated the use of a single select button 130. It is understood, however, that a plurality of such buttons, each with separate visual connections using a plurality of colors or patterns linked to options on a single screen 150, may be provided. Likewise a control panel may include multiple such screens, each provided with one or more such select buttons.

Also, while it is preferred that the first and second light portions form a continuous illuminated region between the select button 130 and the currently selected option on the screen, it is understandable that this may not always be possible due to the physical arrangement of the screen. Thus, the light pipe and/or the light bar may not always touch the screen edge. However, even when some separation between the two is present, the visual connectedness effect may be achieved.

Furthermore, the foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A control panel comprising:
at least one screen configured to display at least one selectable option;
a user interface comprising at least one button configured to select said at least one option, when said first button is activated; and
a visual connection between the at least one button and the at least one option, the visual connection comprising:
a first light portion extending between the at least one button and a first point proximate an edge of the screen; and
a second light portion extending between a second point within the screen and the at least one option displayed on the screen,
wherein the first and second points are sufficiently close to one another so as establish an association between the at least one button and the at least one option.

2. The control panel of claim 1, wherein the first light portion comprises a light pipe extending between the at least one button and the first point.

3. The control panel of claim 2, further comprising an illuminated region adjacent the at least one button, the illuminated region being optically connected to the light pipe.

4. The control panel of claim 3, wherein the illuminated region forms a halo around the at least one button.

5. The control panel of claim 1, wherein a width of the first light portion at the first point is similar to a width of the second light portion at the second point.

6. The control panel of claim 1, wherein a color of the first light portion is similar to a color of the second light portion.

7. The control panel of claim 1, wherein a visual pattern of said first light portion is similar to a visual pattern of the second light portion.

8. The control panel of claim 1, wherein sections of the first light portion and the second light portion, proximate the edge of the screen, are collinear.

9. The control panel of claim 1, wherein at least one of the first light portion and the second light portion flash to draw attention to the association between the at least one button and the at least option.

10. The control panel of claim 9, wherein both the first light portion and the second light portion flash to draw attention to the association between the at least one button and the at least option.

11. The control panel of claim 1, wherein the second light portion comprises an illuminated on-screen text bar interposed between the second point and the currently selectable option.

12. The control panel of claim 1, wherein the at least one button is provided with a translucent symbol on a surface thereof.

13. The control panel of claim 1, wherein a color of the first light portion is different from a color of the second light portion.

14. A control panel comprising:
at least one screen configured to display an object along with information about a status of the object, the information being displayed at a predetermined location on the screen;
a user interface comprising at least one button configured to affect the status of said object; and
a visual connection between the at least one button and the information, the visual connection comprising:
a first light portion extending between the at least one button and a first point proximate an edge of the screen; and
a second light portion extending between a second point within the screen and the predetermined location,
wherein the first and second points are sufficiently close to one another so as establish an association between the at least one button and the information.

15. The control panel of claim 14, wherein:
the at least one button is provided with a first symbol on a surface thereof;
the information comprises a second symbol having a shape similar to that of the first symbol.

16. The control panel of claim 15, wherein:
a color of the first and second symbols are similar.

17. The control panel of claim 14, wherein the information signifies whether the object has been selected.

18. The control panel of claim 17, wherein activating the at least one button causes the status of the object to change from being selected to not being selected.

19. A method of linking an option displayed on a screen to a button configured to select the option, the button not being on the screen, the method comprising:
illuminating a first light portion extending between the button and a first point proximate an edge of the screen; and
illuminating a second light portion extending between a second point within the screen and the at least one option displayed on the screen,
wherein the first and second points are sufficiently close to one another so as establish an association between the at least one button and the at least one option.

20. The method of claim 19, wherein:
a width of the first light portion at the first point is similar to a width of the second light portion at the second point; and
a color or visual pattern of the first light portion is similar to a color or visual pattern of the second light portion.

21. The method of claim 19, further comprising flashing at least one of the first and second light portions.
